(19) United States
(12) Patent Application Publication
(10) Pub. No.: US 2026/0072170 A1
(43) Pub. Date: Mar. 12, 2026

(54) APPARATUS, SYSTEM, AND METHOD FOR GENERATING GRID MAP

(71) Applicant: ELECTRONICS AND TELECOMMUNICATIONS RESEARCH INSTITUTE, Daejeon (KR)

(72) Inventors: Ji Hun Jeon, Daejeon (KR); Sang Gi Hong, Daejeon (KR)

(21) Appl. No.: 19/321,126

(22) Filed: Sep. 5, 2025

Related U.S. Application Data
(60) Provisional application No. 63/736,193, filed on Dec. 19, 2024.

(30) Foreign Application Priority Data
Sep. 9, 2024 (KR) 10-2024-0122436
Feb. 26, 2025 (KR) 10-2025-0025015

(51) Int. Cl. G01S 17/89; G01C 21/00; G01S 17/87; G06T 11/00; G06V 10/74; G06V 20/10

(52) U.S. Cl. CPC G01S 17/89; G01C 21/383; G01S 17/87; G06T 11/10; G06V 10/761; G06V 20/176

(57) ABSTRACT

An apparatus for generating a grid map includes: a camera; a lidar sensor; a memory configured to store an indoor building layout associated with a plurality of reference facilities inside a building; and a processor, wherein the processor is configured to: generate a 2D grid map by detecting an interior of the building using the lidar sensor, recognize landmarks corresponding to the plurality of reference facilities through the camera while generating the 2D grid map, and display the landmarks corresponding to the plurality of reference facilities at actual positions of the reference facilities on the 2D grid map; match the 2D grid map with the indoor building layout based on positions of the landmarks on the 2D grid map and positions of the reference facilities on the indoor building layout; and visually highlight and display portions of the 2D grid map, which do not match the indoor building layout.

### CROSS-REFERENCE TO RELATED APPLICATIONS

This application claims priority to and the benefit of Korean Patent Applications No. 10-2024-0122436, filed on Sep. 9, 2024, and No. 10-2025-0025015, filed on Feb. 26, 2025, and U.S. Provisional Patent Application No. 63/736,193, filed on Dec. 19, 2024, the disclosure of which is incorporated herein by reference in its entirety.

### BACKGROUND

### 1. Field of the Invention

Various embodiments disclosed in this document relate to lidar-based map generation technology.

### 2. Discussion of Related Art

A lidar emits laser pulses and calculates distances to nearby objects based on the time of flight of the pulses which are reflected from the nearby objects and return. By combining distance data with each scanning angle of a lidar sensor, a lidar can generate two-dimensional (2D) or three-dimensional (3D) point cloud information about the nearby objects. Therefore, a lidar can generate a precise 2D grid map based on point clouds that detect walls, obstacles, etc., in the surrounding environment, and is utilized in various fields for purposes such as robot navigation, autonomous driving, and indoor map generation.

An apparatus for generating a lidar-based 2D grid map can generate a map that reflects the arrangement of furniture or objects in the actual space.

### SUMMARY OF THE INVENTION

Such a 2D grid map can be useful for robots to plan movement paths while avoiding obstacles or to recognize their own current locations. However, it is difficult for humans to directly interpret and utilize the 2D grid map. However, since humans are the main operators of the robots, it is necessary to compare building floor plans that are easy for humans to understand with 2D grid map generated by the robot and determine the location of the robot or remotely control the robot based on the 2D grid map.

Various embodiments disclosed in this document can provide an apparatus, system, and method for generating a grid map that can enhance user visibility in association with an indoor building layout.

An apparatus for generating a grid map according to an embodiment of the disclosure may include: a camera; a lidar sensor; a memory configured to store an indoor building layout associated with a plurality of reference facilities inside the building; and a processor functionally connected to the camera, the lidar sensor, and the memory, wherein the processor is configured to generate a two-dimensional (2D) grid map by detecting an interior of a building using the lidar sensor, recognize landmarks corresponding to the plurality of reference facilities through the camera while generating the 2D grid map and associate the landmarks with the 2D grid map, match the 2D grid map with the indoor building layout based on positions of the landmarks on the 2D grid map and positions of the reference facilities on the indoor building layout, and visually highlight and display portions of the 2D grid map, which do not match the indoor building layout.

In addition, a system for generating a grid map according to an embodiment of the disclosure may include: a robot device including a lidar sensor and a camera; and a server device configured to store an indoor building layout including a plurality of reference facilities, wherein the robot device generates a 2D grid map of an interior of a building using the lidar sensor, extracts first coordinate data related to positions of landmarks corresponding to the plurality of reference facilities recognized through the camera, and transmits the extracted first coordinate data to the server device, and the server device matches the 2D grid map with the indoor building layout based on second coordinate data of the reference facilities corresponding to the first coordinate data on the indoor building layout and visually highlights and displays portions of the 2D grid map, which do not match the indoor building layout.

In addition, a method for generating a grid map according to an embodiment of the disclosure may include: generating a 2D grid map of an interior of a building using a lidar sensor and recognizing positions of reference facilities of the interior of the building through a camera; displaying landmarks corresponding to the reference facilities at the corresponding positions on the 2D grid map; matching the 2D grid map with an indoor building layout based on the positions of the landmarks on the 2D grid map and the positions of the reference facilities on the indoor building layout; and visually highlighting portions where the 2D grid map and the indoor building layout do not match each other.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other objects, features and advantages of the disclosure will become more apparent to those of ordinary skill in the art by describing exemplary embodiments thereof in detail with reference to the accompanying drawings, in which:

FIGS. 1 to 3 are views illustrating differences between a two-dimensional (2D) grid map and an indoor building layout;

FIG. 4 is a block diagram illustrating a system for generating a grid map according to an embodiment;

FIGS. 5 to 11 are views illustrating a matching process between a 2D grid map and an indoor building layout; and

FIG. 12 is a flowchart illustrating a method for generating a grid map according to an embodiment.

In relation to the description of drawings, like reference numerals may be used for like components.

### DETAILED DESCRIPTION OF EXEMPLARY EMBODIMENTS

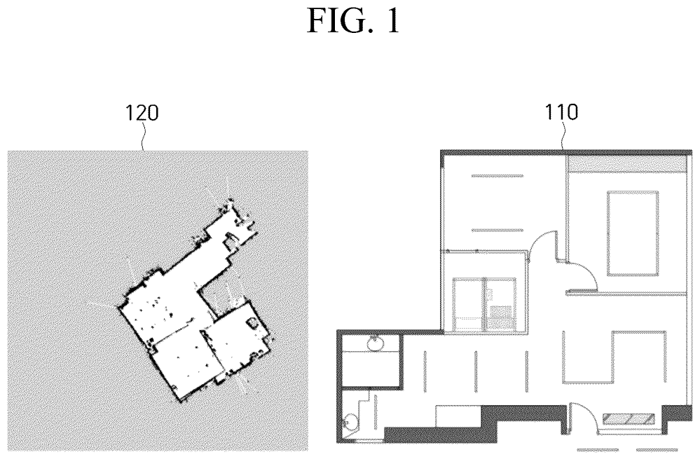

The relationship between a building blueprint (indoor building layout) and a two-dimensional (2D) grid map is similar to the relationship between a programming language used by a person and a machine language understood by a central processing unit (CPU). Obviously, it would be desirable for humans to intuitively interpret the 2D grid map. However, due to the following issues, such intuitive interpretation is difficult to be achieved in unfamiliar environments. Hereinafter, the differences between the 2D grid map and the building floor plan will be described with reference to FIGS. 1 to 3.

First, the coordinate axes of the building floor plan and the 2D grid map are different. The floor plan is typically designed so that the outer walls of the building are parallel to the horizontal and vertical axes (see reference numeral 110 in FIG. 1), but the coordinate axes of the 2D grid map are determined according to the starting direction of the robot movement, so the walls in the 2D grid map may appear tilted (see reference numeral 120 in FIG. 1). Therefore, the user may feel confused about the sense of direction when interpreting the grid map.

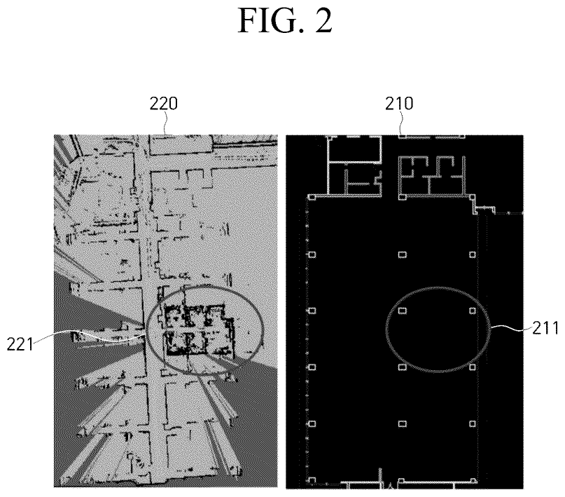

Second, display methods of the building floor plan and the 2D grid map for the same space are different. The building floor plan only shows major structures such as exterior walls, doors, pillars, stairs, etc., whereas the 2D grid map reflects actually placed objects such as desks, chairs, and partitions inside the room. For example, an office is simply depicted as a large space in a building floor plan (210 in FIG. 2), but the actual 2D grid map includes desks, chairs, partitions, etc. (220 in FIG. 2). Due to this difference, discrepancies may occur between the building floor plan and the 2D grid map even for the same space (see reference numerals 211 and 221 in FIG. 2), and in particular, a person who is not familiar with the space has difficulty in matching the building floor plan and the 2D grid map.

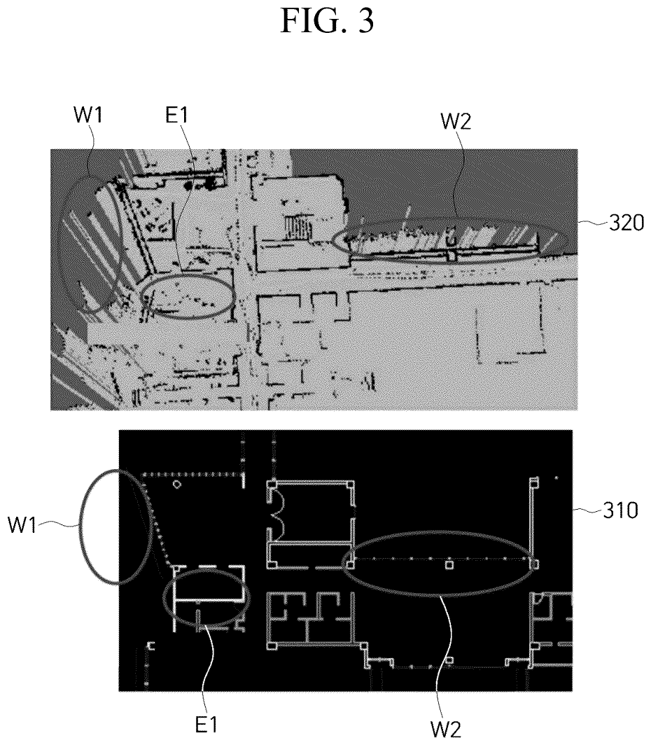

Third, a lidar has limitations and noise due to its measurement method. Specifically, since a lidar measures the distance to nearby objects based on laser reflections, it is impossible to acquire point cloud data for areas that are obscured by obstacles, inaccessible areas, or external areas such as the exterior walls of a building. In addition, reflective surfaces like windows or mirrors may cause a lidar to measure false images rather than actual distances from the windows or mirrors, resulting in noise in the point cloud data. Furthermore, noise caused by moving objects (e.g., people) or reflective surfaces may be displayed similarly to walls, which can interfere with the alignment with the actual map. For example, as shown in a building floor plan 310 and a 2D grid map 320 in FIG. 3, a lidar may mistakenly detect areas beyond windows (W1, W2) or interpret elevator areas (E1) as enclosed areas like walls.

However, matching the 2D grid map and the indoor building layout (i.e., indoor floor plan of the building) is essential in various situations where robots interact with humans. In particular, in situations where the robot is remotely controlled or a person monitors the location of the robot to issue control commands, the 2D grid map is required to match the indoor building layout so that the 2D grid map can be easily understood and appropriate instructions can be issued. Furthermore, although the indoor building layout is provided in a structure that can be intuitively understood by a person, the indoor building layout does not reflect changes in the environment or indoor building layout. Therefore, for a person to easily determine the robot's current location and issue precise control commands, it is necessary for the 2D grid map to match the indoor building layout.

To address these issues, the 2D grid map is manually matched with the building floor plan by a person who has prior knowledge of the building layout. In this manner, personnel with prior knowledge of the building layout are required to match the 2D grid map with the building floor plan.

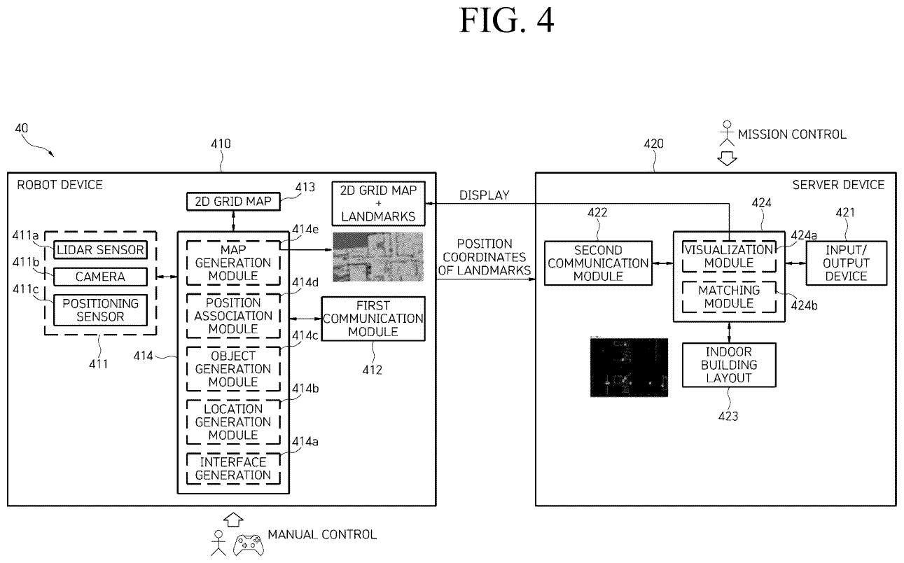

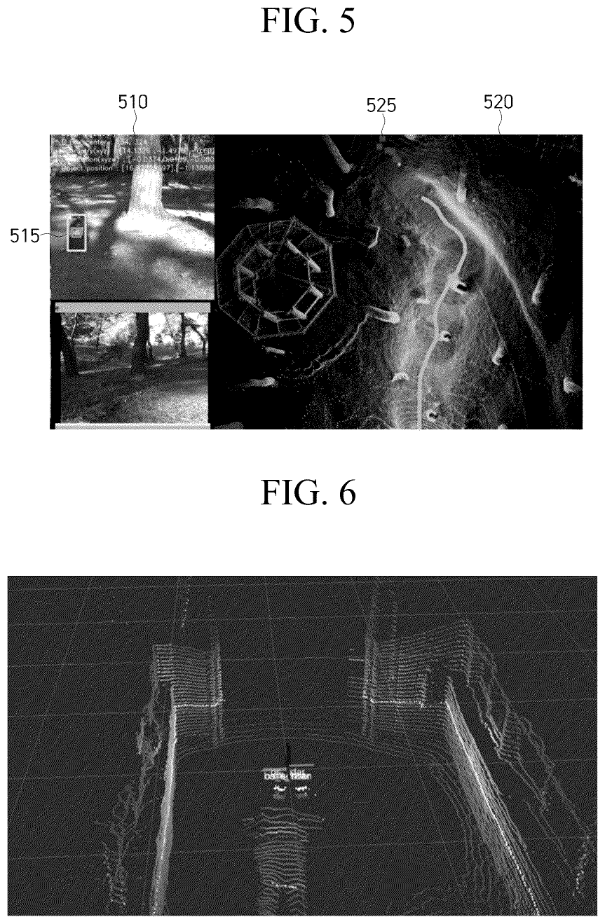

FIG. 4 is a block diagram illustrating a system for generating a grid map according to an embodiment, and FIGS. 5 to 11 are drawings illustrating a matching process between a 2D grid map and an indoor building layout.

Referring to FIG. 4, a system 40 for generating a grid map according to an embodiment may include a robot device 410 and a server device 420.

The robot device 410 may include a sensor module 411, a first communication module 412, a first memory 413, and a first processor 414. In an embodiment, the robot device 410 may exclude some components or may further include additional components. For example, the robot device 410 may further include modules (e.g., wheels) related to robot movement and mobility. In addition, some of the components of the robot device 410 may be integrated into a single entity while still performing the same functions as the individual components before integration.

The sensor module 411 may include a lidar sensor 411a, a camera 411b, and a positioning sensor 411c. The lidar sensor 411a may emit laser beams and measure distances to nearby objects based on signals reflected and received from the nearby objects of the robot device 410. The camera 411b may photograph the surrounding environment of the robot device 410 under the control of the first processor 414. The positioning sensor 411c may include a global positioning system (GPS) sensor and a motion sensor (e.g., an inertial measurement unit (IMU), a gyro sensor, and an acceleration sensor). The positioning sensor 411c may measure the current location of the robot device 410 under the control of the first processor 414.

The first communication module 412 may support to establish a communication channel or a wireless communication channel between the robot device 410 and another device (e.g., the server device 420) and perform communication through the established communication channel. The communication channel may include, for example, at least one of WiBro, Wireless LAN, Wi-Fi, Bluetooth, ZigBee, Wi-Fi Direct (WFD), Ultra-wideband (UWB), Infrared Data Association (IrDA), Bluetooth Low Energy (BLE), Near Field Communication (NFC), 3G, 4G, 5G or 6G.

The first memory 413 may include various types of volatile memory or nonvolatile memory. For example, the first memory 413 may include a ROM and a RAM. In an embodiment, the first memory 413 may be located inside or outside the robot device 410 and may be connected to the first processor 414 via various means known in the art. The first memory 413 may store a various types of data used by at least one component of the robot device 410 (e.g., the first processor 414). The data may include, for example, input data or output data for software and commands related thereto. For example, the first memory 413 may store at least one instruction and data for generating and calibrating a 2D grid map.

The first processor 414 may control at least one other component (e.g., hardware or software component) of the robot device 410 and perform various data processing or computations. The first processor 414 may include, for example, at least one of a CPU, a graphics processing unit (GPU), a microprocessor, an application processor, an application-specific integrated circuit (ASIC), and a field-programmable gate array (FPGA), and may have multiple cores. The first processor 414 may include an interface module 414a, a location recognition module 414b, an object recognition module 414c, a position association module 414d, and a map generation module 414e. The interface module 414a, the location recognition module 414b, the object recognition module 414c, the position association module 414d, and the map generation module 414e may be software/hardware modules included in the first processor 414 or executed by the first processor 414.

When receiving manual control (e.g., remote control) information of a user, the interface module 414a may control the movement of the robot device 410 according to the received control information.

The location recognition module 414b may recognize the current location of the robot device 410 based on detection results from the positioning sensor 411c.

The object recognition module 414c may detect nearby objects of the robot device 410 using images captured by the camera 411b. The object recognition module 414c may include an artificial intelligence (AI) model trained to recognize objects, including reference facilities. The object recognition module 414c may recognize objects based on feature values of the captured images using the AI model. The object recognition module 414c may display the type and location of the recognized object as a bounding box, and the pixel coordinate values of each object may be calculated. The object recognition module 414c may distinguish and recognize the reference facilities through the AI model and output the pixel coordinate values of the recognized reference facilities.

The position association module 414d may perform precise calibration to match the pixel coordinate values of the camera 411b with 3D point cloud data of the lidar sensor 411a. The position association module 414d may calculate a transformation matrix value to align the 2D image coordinate system of the camera 411b with the 3D point cloud data of the lidar sensor 411a through precise calibration. The position association module 414d may apply the calculated transformation matrix value to the pixel coordinate values of the recognized object and calculate direction vectors for the recognized object based on the lidar sensor 411a. When the object is recognized by the object recognition module 414c, the position association module 414d may extract the 3D point cloud data of the lidar sensor 411a from the same directional range as the pixel coordinate values of the object including the facilities. The position association module 414d may remove noise from the extracted 3D point cloud data and generate a 3D position of the object.

As shown in a first image 510 of FIG. 5, the first processor 414 may use the camera 411b to capture an indoor fire hydrant as the reference facility in the building, detect the indoor fire hydrant in the captured image through the object recognition module 414c, and display the detected indoor fire hydrant with a bounding box (yellow box, 515). The position association module 414d may match the pixel coordinate values of the bounding box with the point cloud data of the lidar sensor 411a. Accordingly, the position association module 414d may acquire the precise location of the indoor fire hydrant (see a red mark 525 of FIG. 5) from the 3D point cloud data.

The map generation module 414e may generate point cloud data of a coordinate system with the lidar sensor 411a as the origin based on detection signals of the lidar sensor 411a with respect to the interior of the building. The map generation module 414e may perform a simultaneous localization and mapping (SLAM) algorithm using the point cloud data and continuously acquire and accumulate the movement position and direction of the robot device 410 using the position (current location detected by the positioning sensor 411c) and direction of the lidar sensor 411a as the origin of the coordinate system.

The map generation module 414e may generate 2D point cloud data by removing a height value higher than a specific height value from the 3D point cloud data or extracting only a height value in a specific range. Point clouds for the floor are not considered obstacles, and the walls and nearby objects are easily visible at a specific height range. Accordingly, the map generation module 414e may extract 3D point cloud data having a specific range of height values where the walls and nearby objects are clearly revealed, and generate a flat map (2D grid map). For example, referring to FIG. 6, the map generation module 414e may convert 3D point cloud data (shown in red points or lines) into 2D point cloud data (shown in white points or lines).

The map generation module 414e may convert 2D point cloud data into a 2D grid map based on known techniques. The 2D grid map is displayed so that the current location of the robot device 410 and the walls and obstacles inside the building can be clearly distinguished. The 2D grid map is used for path planning and location tracking of the robot device 410.

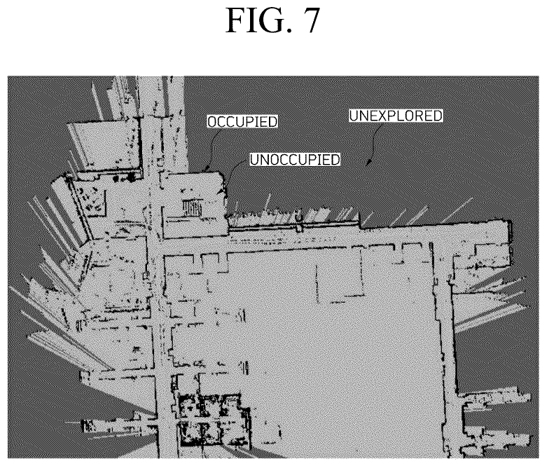

Referring to FIG. 7, the 2D grid map may include grid cells divided into three states: an occupied state (indicated by black areas), an unoccupied state (indicated by light gray areas), and an unexplored state (indicated by dark gray areas). For example, a cell in the occupied state may represent an area in which 2D point cloud data is present due to objects such as walls, furniture, or obstacles with respect to the origin coordinate system. A cell in the unoccupied state may represent a space in which the robot device 410 can move, having been explored as an area with no objects between the 2D point cloud data and the lidar sensor 411a. A cell in the unexplored state may represent an area that has not yet been explored by the lidar sensor 411a, such as an area that the robot device 410 has not approached or is not included in the detection range.

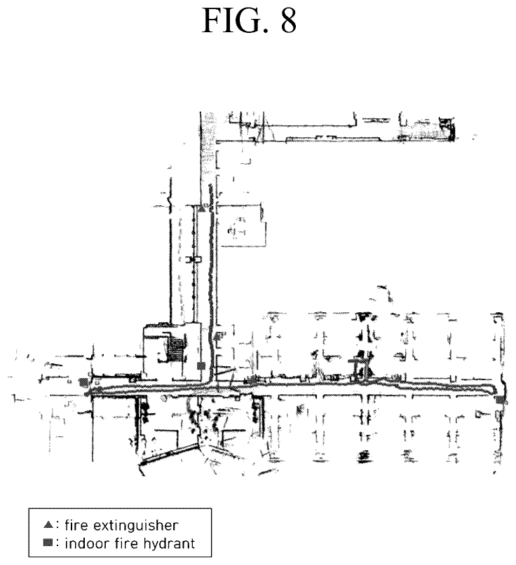

The map generation module 414e may include the position coordinates (hereinafter, referred to as “first position coordinates”) of reference facilities, which are recognized through the camera 411b and the object recognition module 414c, in the 2D grid map. For example, the map generation module 414e may display landmarks corresponding to the reference facilities at the position coordinates of the reference facilities on the 2D grid map and associate the landmarks with the first position coordinates. In another example, the map generation module 414e may display unique landmarks at the positions of the reference facilities so that the reference facilities are distinguishable from other occupied grid cells. Referring to FIG. 8, the landmarks may be specified shapes (e.g., circles, triangles, rectangles) or facility icons. In FIG. 8, for example, an indoor fire hydrant is shown as a rectangle and a fire extinguisher is shown as a triangle, but are not limited thereto. Since these landmarks are fixed structures that are easily recognizable indoors, the landmarks can serve as reference points when a user interprets the 2D grid map or performs robot path planning or location tracking based on the 2D grid map.

The first processor 414 may transmit the 2D grid map, which includes 2D point cloud data and first position coordinates of the landmarks to the server device 420 via the first communication module 412.

The server device 420 may include an input/output device 421, a second communication module 422, a second memory 423, and a second processor 424.

The input/output device 421 may include an input circuit that acquires or detects a user's input and a display that displays text, objects, or images under the control of the second processor 424.

The second communication module 422 may support the establishment of a communication channel or a wireless communication channel between the server device 420 and another device (e.g., the robot device 410), and the performance of communication through the established communication channel. The communication channel may include, for example, at least one of WiBro, Wireless LAN, Wi-Fi, Bluetooth, ZigBee, WFD, UWB, IrDA, BLE, NFC, 3G, 4G, 5G or 6G. For example, the second communication module 422 may acquire the first position coordinates of the landmark and transmit the acquired first position coordinates to the second processor 424.

The second memory 423 may include various types of volatile memory or nonvolatile memory. For example, the second memory 423 may include a read-only memory (ROM) and a random access memory (RAM). In an embodiment, the second memory 423 may be located inside or outside the server device 420 and may be connected to the second processor 424 via various means known in the art. The second memory 423 may store a various types of data used by at least one component of the server device 420 (e.g., the second processor 424). The data may include, for example, input data or output data for software and commands related thereto. For example, the second memory 423 may store at least one instruction and data for calibrating a 2D grid map. The second memory 423 may store an indoor building layout associated with the position coordinates of the reference facilities (hereinafter, referred to as “second position coordinates”). The indoor building layout may be, for example, a fire protection plan indicating the legally fixed positions of fire safety facilities.

The second processor 424 may control at least one other component (e.g., hardware or software component) of the server device 420 and perform various data processing or computations. The second processor 424 may include, for example, at least one of a CPU, a GPU, a microprocessor, an application processor, an ASIC, and an FPGA, and may have multiple cores. The second processor 424 may include a matching module 424a and a visualization module 424b. The matching module 424a and the visualization module 424b may be software/hardware modules included in the second processor 424 or executed by the second processor 424.

The second processor 424 may acquire first position coordinates and a 2D grid map of a landmark through the second communication module 422.

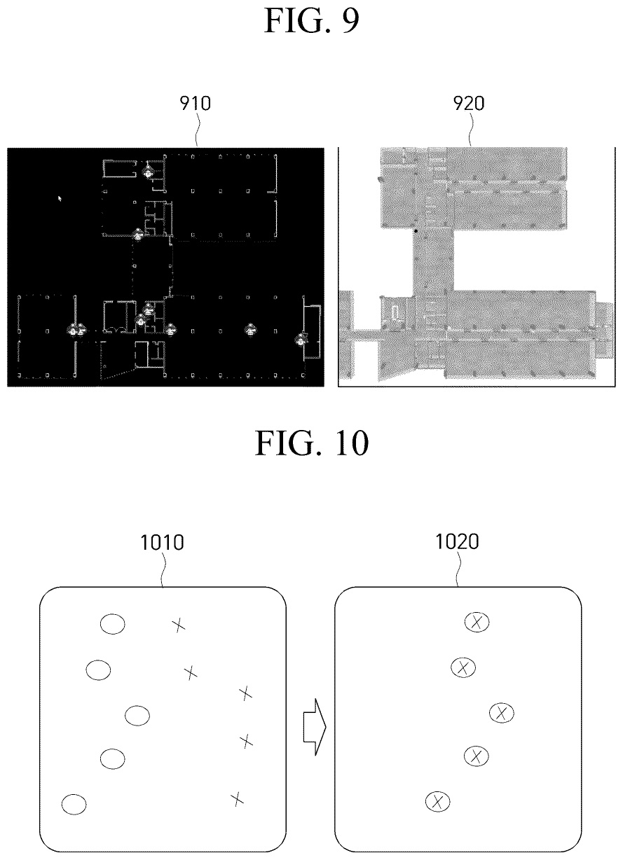

The matching module 424a may convert an indoor building layout stored in the second memory 423 into a format interpretable by the second processor 424, and extract (or generate or convert) the position coordinates of reference facilities (hereinafter, referred to as “second position coordinates”) from the indoor building layout. Referring to FIG. 9, the matching module 424a may convert the indoor building layout into a 2D diagram 910 or a 3D diagram 920.

In addition, the matching module 424a may identify the first position coordinates of landmarks in the 2D grid map acquired from the robot device 410.

The matching module 424a may match the first position coordinates of the landmarks and the second position coordinates of the reference facilities using an iterative closest point (ICP) matching algorithm. The matching module 424a may determine a transformation matrix (T) as shown in Equation 1 below, which enables the conversion of the first position coordinates to the second position coordinates using an ICP matching algorithm. As shown in Equation 1, the transformation matrix may include, for example, a rotation value, a parallel translation value, and a scale factor for converting the first position coordinates to the second position coordinates.

T=sR·X+t [Equation 1]

In Equation 1, R denotes a rotation matrix, t denotes a parallel translation vector, s denotes a scale factor, and X denotes coordinate values of a 2D grid map. The rotation matrix may include rotation values for rotating the direction of the 2D grid map to match the orientation of the indoor building layout, thereby ensuring directional alignment between the indoor building layout and the 2D grid map. The parallel translation vector may include vector values that shift the 2D grid map to correspond to the indoor building layout so that the relative positions of the 2D grid map and the indoor building layout align with each other. The scale factor may include scaling values for enlarging/reducing the coordinate values of the 2D grid map to match the scale of the indoor building layout.

For determining the transformation matrix using the ICP algorithm, the matching module 424a may set, as initial corresponding points, the coordinates with the nearest Euclidean distance between the first position coordinates of the 2D grid map and the second position coordinates of the indoor building layout. After setting the initial corresponding points, the matching module 424a may calculate the nearest corresponding points between the first position coordinates and the second position coordinates of the reference facilities. The matching module 424a measures the Euclidean distance between the nearest corresponding points and iteratively identifies and matches the nearest points. The matching module 424a may calculate a transformation matrix to adjust the corresponding coordinate values to be more consistent with each other. The matching module 424a may calculate a matching error between the first position coordinates and the second position coordinates using the calculated transformation matrix. The matching error is a distance difference between the corresponding points, and the smaller the distance difference, the more accurately the corresponding points are matched. When the matching error is reduced to be equal to or lower than a threshold, the matching module 424a may determine that the ICP algorithm has converged, terminate the iterative process of the ICP algorithm (setting the initial corresponding points, calculating the nearest points, calculating the transformation matrix, and calculating the matching error), and determine the transformation matrix. On the other hand, when the matching error exceeds the threshold, the matching module 424a may determine that the ICP algorithm has not converged and repeat the process of the ICP algorithm (setting the initial corresponding points, calculating the nearest points, calculating the transformation matrix, and calculating the matching error).

Next, the matching module 424a may apply the determined transformation matrix to all the cells of the 2D grid map and perform matching such that the facility coordinates of the 2D grid map align with those of the indoor building layout. For example, in an illustration 1010 of FIG. 10, there is a positional discrepancy between circle-marked regions in the indoor building layout and cross-marked regions in the 2D grid map. On the other hand, in an illustration 1020 of FIG. 10, the matching module 424a may align the position coordinates of the circle-marked regions in the indoor building layout with the cross-marked regions in the 2D grid map using the ICP algorithm.

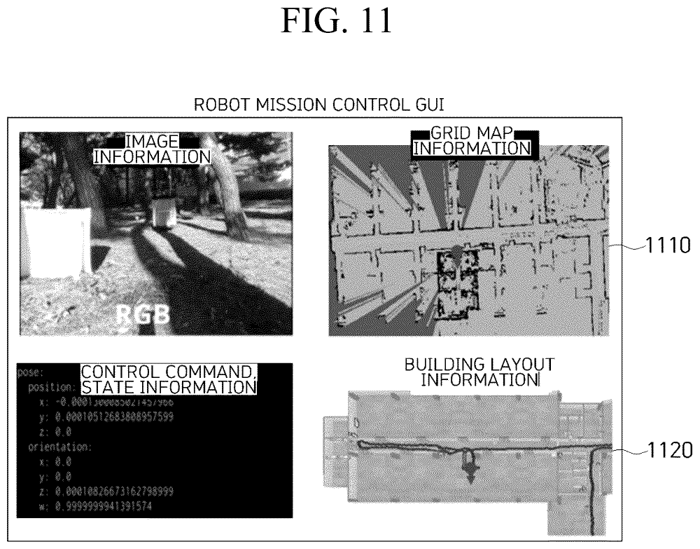

The visualization module 424b may visually highlight areas where the matched indoor building layout and 2D grid map do not align with each other. For example, the visualization module 424b may match 2D point cloud data of the 2D grid map with the coordinate system of the indoor building layout using the transformation matrix. The visualization module 424b may detect non-matching portions through a similarity analysis between the point cloud data of the 2D grid map calibrated with the same coordinate system and the cells of the indoor building layout. Next, the visualization module 424b may highlight in, for example, red the detected non-matching portions in both the 2D grid map and the indoor building layout. The visualization module 424b may detect, for example, portions where at least an occupied area (walls, obstacle areas) of the indoor building layout is indicated as an unoccupied area or an unexplored area on the 2D grid map, or a door area (including elevators) of the indoor building layout is indicated as an occupied area on the 2D grid map. Referring to FIG. 11, the visualization module 424b may display different portions of a 2D grid map 1110 and an indoor building layout 1120 by highlighting the different portions in red, respectively, through a display (input/output device 421).

The user may identify the highlighted portions (by enlarging them as needed) that do not match each other through the input/output device 421 and perform calibration to match the portions with errors through the input/output device 421. Then, the visualization module 424b may update the portions calibrated by the user to the 2D grid map. The visualization module 424b may provide the updated 2D grid map to the robot device 410 through the second communication module 422. The robot device 410 may update the provided 2D grid map in the first memory 413 and use the updated 2D grid map in the future for the purposes of path planning and location tracking.

In this manner, the system 40 for generating a grid map according to an embodiment may automatically match the 2D grid map generated by the robot device 410 with the indoor building layout based on the positions of the reference facilities which are also displayed on the indoor building layout (fire protection plan) and are installed at a fixed location within the building.

In addition, the system 40 for generating a grid map according to an embodiment may match the 2D grid map with the indoor building layout in terms of axis direction, origin, and scale to highlight the portions that do not match each other, so that the user performing calibration of the 2D grid map may easily identify and accurately edit the 2D grid map, thereby increasing the completeness and accuracy of the 2D grid map.

Furthermore, the system 40 for generating a grid map according to an embodiment may allow the robot device 410 to calibrate the 2D grid map or location tracking based on the results of recognition and position calculation of the reference facilities inside the building while performing path planning and location tracking using the calibrated 2D grid map, thereby improving the efficiency and accuracy of indoor navigation and mission execution.

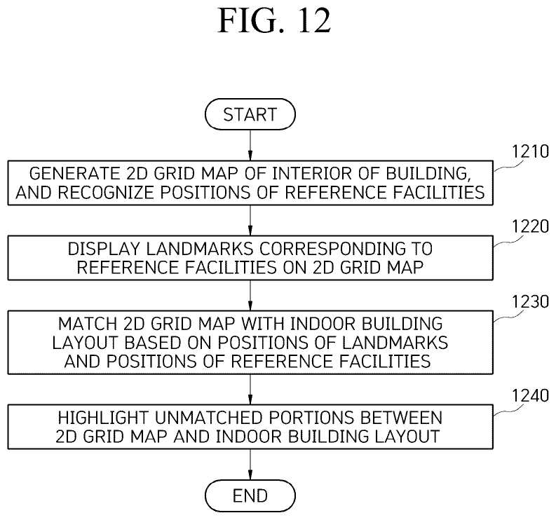

FIG. 12 is a flowchart illustrating a method for generating a grid map according to an embodiment.

Referring to FIG. 12, in operation 1210, an apparatus for generating a grid map (the robot device 410) may generate a 2D grid map of an interior of a building using a lidar sensor 411a and recognize the positions of reference facilities in the interior of the building through a camera.

In operation 1220, the apparatus for generating a grid map (the robot device 410) may display landmarks corresponding to the reference facilities at the corresponding positions on the 2D grid map.

In operation 1230, the apparatus for generating a grid map (the server device 420) may match the 2D grid map with an indoor building layout of the building based on the positions of the landmarks on the 2D grid map and the positions of the reference facilities on the indoor building layout. For example, the robot device 410 may transmit the 2D grid map with the landmarks displayed thereon to the server device 420, and the server device 420 may match the 2D grid map to the indoor building layout based on the position coordinates of the landmarks on the 2D grid map and the position coordinates of the reference facilities on the indoor building layout using the ICP algorithm according to the request of the robot device 410.

In operation 1240, the apparatus for generating a grid map (the server device 420) may visually highlight unmatched portions between the 2D grid map and the indoor building layout. For example, the server device 420 may detect the portions that do not match each other through a similarity analysis between the 2D grid map and the indoor building layout which are matched to each other and may display the detected portions by highlighting them with a specified color.

It is to be understood that various embodiments of the present document and terms used in the embodiments are not intended to limit technological features set forth herein to specific embodiments and include various changes, equivalents, or substitutions for a corresponding embodiment. With regard to the description of the drawings, similar reference numerals may be used to refer to similar or related components. A singular form of a noun corresponding to an item may include one or more of the items unless the relevant context clearly indicates otherwise. As used herein, each of phrases such as “A or B,” “at least one of A and B,” “at least one of A or B,” “A, B, or C,” “at least one of A, B, and C,” and “at least one of A, B, or C” may include any one of or all possible combinations of items enumerated together in a corresponding one of the phrases. Terms such as “1^{st}” and “2^{nd},” or “first” and “second” may be used to simply distinguish a corresponding component from another, and do not limit the components in other aspects (e.g., importance or order). When a (e.g., first) component is referred to, with or without the term “functionally” or “communicatively,” as “coupled” or “connected” to another (e.g., second) component, it means that the first component may be coupled to the second component directly (e.g., by wire), wirelessly, or via a third component.

As used herein, the term “module” may include a unit implemented in hardware, software, or firmware, and may interchangeably used with other terms, for example, “logic,” “logic block,” “part,” or “circuitry.” A module may be a single integral component or a minimum unit or part thereof that performs one or more functions. For example, according to an embodiment, a module may be implemented in the form of an ASIC.

Various embodiments of the present document may be implemented as software (e.g., a program) including one or more instructions stored in a storage medium (e.g., an internal memory, an external memory, or a memory) (e.g., the first or the second memory 413, 423) that is readable by a machine (e.g., the robot device 410, or the server device 420). For example, a processor (e.g., the first or the second processor 414, 424) of the machine may invoke at least one of the one or more instructions stored in the storage medium and execute the at least one invoked instruction. This allows the machine to be operated to perform at least one function according to the at least one invoked instruction. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not distinguish between a case where data is semi-permanently stored in the storage medium and a case where data is temporarily stored in the storage medium.

According to an exemplary embodiment, a method according to various embodiments disclosed in the present document may be included and provided in a computer program product. The computer program product may be traded as a product between a seller and a buyer. The computer program product may be distributed in the form of a machine-readable storage medium (e.g., compact disc (CD)-ROM) or distributed (e.g., downloaded or uploaded) online via an application store (e.g., Play Store™) or directly between two user devices (e.g., smartphones). When the computer program product is distributed online, at least a part of the computer program product may be temporarily generated or at least temporarily stored in the machine-readable storage medium, such as memory of the manufacturer's server, a server of the application store, or a relay server.

Components according to various embodiments of the present document may be implemented in the form of hardware such as a digital signal processor (DSP), an FPGA, or an ASIC and perform certain roles. Components are not limited to software or hardware, and each component may be configured to reside in an addressable storage medium or run on one or more processors. As an example, components may include components, such as software components, object-oriented software components, class components, and task components, processes, functions, attributes, procedures, subroutines, segments of program code, drivers, firmware, microcode, circuitry, data, DBs, data structures, tables, arrays, and variables.

According to various embodiments, each of the above-described components (e.g., modules or programs) may include a single entity or a plurality of entities. According to various embodiments, one or more of the above-described components or operations may be omitted, or one or more other components or operations may be added. Alternatively or additionally, a plurality of components (e.g., modules or programs) may be integrated into a single component. In this case, the integrated component may still perform one or more functions of the plurality of components in the same or similar manner as they are performed by the corresponding components among the plurality of components before the integration. According to various embodiments, operations performed by a module, a program, or another component may be carried out sequentially, in parallel, repeatedly, or heuristically, or at least one of the operations may be executed in a different order or omitted, or one or more other operations may be added.

What is claimed is:

1. An apparatus for generating a grid map, comprising:
a camera;
a lidar sensor;
a memory configured to store an indoor building layout associated with a plurality of reference facilities inside a building; and
a processor functionally connected to the camera, the lidar sensor, and the memory,
wherein the processor is configured to:
generate a two-dimensional (2D) grid map by detecting an interior of the building using the lidar sensor, recognize actual facilities corresponding to the plurality of reference facilities through the camera while generating the 2D grid map, and display landmarks corresponding to the actual facilities at positions of the actual facilities on the 2D grid map;
match the 2D grid map with the indoor building layout based on positions of the landmarks on the 2D grid map and positions of the reference facilities on the indoor building layout; and
visually highlight and display portions of the 2D grid map, which do not match the indoor building layout.

2. The apparatus of claim 1, wherein the processor identifies first coordinate data of the landmarks on the 2D grid map, extracts second coordinate data of the reference facilities on the indoor building layout, and calculates a transformation matrix that matches the first coordinate data and the second coordinate data using an iterative closest point (ICP) matching algorithm.

3. The apparatus of claim 2, wherein the processor sets nearest corresponding points based on a Euclidean distance between the first coordinate data and the second coordinate data and determines the transformation matrix in which a matching error between the first coordinate data and the second coordinate data is less than or equal to a threshold based on the nearest corresponding points.

4. The apparatus of claim 2, wherein the processor calculates the transformation matrix including at least one of a rotation value, a parallel translation value, and a scale factor when converting the first coordinate data into the second coordinate data.

5. The apparatus of claim 2, wherein the processor calibrates the 2D grid map to match a coordinate system of the indoor building layout using the transformation matrix and detects portions that do not match each other through a similarity analysis between the 2D grid map and the indoor building layout.

6. The apparatus of claim 2, wherein the processor detects portions where at least an occupied area of the indoor building layout is indicated as an unoccupied area or an unexplored area on the 2D grid map, or a door area of the indoor building layout is indicated as an occupied area on the 2D grid map.

7. The apparatus of claim 1, wherein the indoor building layout includes a fire protection plan containing firefighting facilities, which are the reference facilities.

8. The apparatus of claim 1, wherein the processor matches a coordinate system of the camera with a coordinate system of the lidar sensor and then associates the positions of the recognized landmarks with the 2D grid map through the camera.

9. The apparatus of claim 1, further comprising:
a display; and
a memory configured to store the generated 2D grid map,
wherein, when the highlighted 2D grid map is calibrated, the processor updates the calibrated 2D grid map in the memory and displays the updated 2D grid map on the display in association with at least a portion of the indoor building layout.

10. The apparatus of claim 9, further comprising a positioning sensor,
wherein the processor detects a current location of the apparatus using the positioning sensor during movement using the 2D grid map and calibrates the 2D grid map based on the detected landmarks when at least one of the landmarks is detected through the camera at the current location.

11. A system for generating a grid map, comprising:
a robot device including a lidar sensor and a camera; and
a server device configured to store an indoor building layout including a plurality of reference facilities,
wherein the robot device generates a 2D grid map of an interior of a building using the lidar sensor, extracts first coordinate data associated with positions of landmarks corresponding to the plurality of reference facilities recognized through the camera, and transmits the extracted first coordinate data to the server device, and
the server device matches the 2D grid map with the indoor building layout based on second coordinate data of the reference facilities corresponding to the first coordinate data on the indoor building layout and visually highlights and displays portions of the 2D grid map, which do not match the indoor building layout.

12. The system of claim 11, wherein the server device identifies the first coordinate data from the 2D grid map, extracts the second coordinate data from the indoor building layout, and calculates a transformation matrix between the first coordinate data and the second coordinate data using an iterative closest point (ICP) matching algorithm to match the 2D grid map with the indoor building layout.

13. The system of claim 12, wherein the server device sets nearest corresponding points based on an Euclidean distance between the first coordinate data and the second coordinate data and determines the transformation matrix in which a matching error between the first coordinate data and the second coordinate data is less than or equal to a threshold based on the nearest corresponding points.

14. The system of claim 12, wherein the server device calculates the transformation matrix including at least one of a rotation value, a parallel translation value, and a scale factor when converting the first coordinate data into the second coordinate data.

15. The system of claim 12, wherein the server device calibrates the 2D grid map to match a coordinate system of the indoor building layout using the transformation matrix and detects portions that do not match each other through a similarity analysis between the 2D grid map and the indoor building layout.

16. The system of claim 12, wherein the server device detects portions where at least an occupied area of the indoor building layout is indicated as an unoccupied area or an unexplored area on the 2D grid map, or a door area of the indoor building layout is indicated as an occupied area on the 2D grid map.

17. The system of claim 11, wherein the robot device matches a coordinate system of the camera with a coordinate system of the lidar sensor and then associates the positions of the recognized landmarks with the 2D grid map through the camera to extract the first coordinate data.

18. The system of claim 11, wherein, when the highlighted 2D grid map is calibrated by a user, the server device updates and stores the calibrated 2D grid map and displays the updated 2D grid map to the user in association with at least a portion of the indoor building layout.

19. The system of claim 18, wherein the robot device further includes a position detection sensor, detects a current location of the robot device using the position detection sensor during movement within the building using the 2D grid map, and calibrates the 2D grid map based on the detected at least one of the landmarks when at least one of the landmarks is detected through the camera at the current location.

20. A method for generating a grid map, comprising:
generating a 2D grid map of an interior of a building using a lidar sensor and recognizing positions of reference facilities of the interior of the building through a camera;
displaying landmarks corresponding to the reference facilities at positions corresponding to the reference facilities on the 2D grid map;
matching the 2D grid map with an indoor building layout of the building based on the positions of the landmarks on the 2D grid map and the positions of the reference facilities on the indoor building layout; and
visually highlighting portions where the 2D grid map and the indoor building layout do not match each other.
